(19) United States
(12) Patent Application Publication
(10) Pub. No.: US 2026/0292495 A1
(43) Pub. Date: Sep. 24, 2026

(54) METHOD OF OPERATING A TELECOMMUNICATIONS SYSTEM AND A TELECOMMUNICATIONS SYSTEM

(71) Applicant: British Telecommunications Public Limited Company, London, Greater London (GB)

(72) Inventors: Fadi EL-MOUSSA, London, Greater London (GB); Andrew REEVES, London (GB); Tom BOWMAN, London (GB)

(21) Appl. No.: 19/168,736

(22) PCT Filed: Feb. 1, 2024
(86) PCT No.: PCT/EP2024/052470

§ 371 Date: Sep. 24, 2025

(30) Foreign Application Priority Data
Mar. 29, 2023 (EP) 23164962.5

(51) Int. Cl. H04W 12/069; H04L 9/40; H04W 12/03; H04W 12/60

(52) U.S. Cl. CPC H04W 12/069; H04L 63/0807; H04W 12/03; H04W 12/66

(57) ABSTRACT

A method (200) of operating a telecommunications system (100), said telecommunications system comprising a: client device (110); certification server (120) for generating a ticket for the client device; and network server (130) for authenticating the client device using the ticket; the method comprising the steps of: selecting, by the certification server, a parameter associated with the client device (210); generating, by the certification server, a: rule for the selected parameter; ticket for authenticating the client device, wherein the ticket comprises (220): a parameter identifier for identifying to the client device the selected parameter; the rule; processing the ticket, by the client device, so as to retrieve the parameter identifier, and subsequently retrieving a data value for the selected parameter (240); generating a communication, by means of the client device, comprising the retrieved data value in cryptographic association with the ticket (250); communicating, by the client device, the communication to the network server; and decrypting and processing (260), by the network server, the communication so as to determine whether: the client device is trusted; and the retrieved data value is compliant with the rule (270).

### FIELD OF INVENTION

The present invention relates to a method of operating a telecommunications system, and in particular using tickets to audit compliance of a client device with predefined rules.

### BACKGROUND

The “Internet of Things” (IoT) grants connectivity to traditionally non-networked devices, such as sensors (e.g. temperature or optical). Some applications of IoT devices include people counting (i.e. footfall measurement), monitoring of vehicular traffic, air quality analysis, temperature and other environmental measurement, and control systems for streetlights or vehicular traffic signals.

IoT is expected to create a large volume of networked devices, which may be provided in all manner of environments, from rural to urban, and residential to industrial. The number of IoT devices that are being connected to each other and to the “Cloud” over the Internet is estimated to be in the tens of billions, and this is expected to grow.

Many of these IoT devices have low processing power (and are, for example, based around a Raspberry Pi®, a small factor PC or an Application-Specific Integrated Circuit), and may be configured to be left in situ unattended for long periods of time. For example, IoT water meters may have lifespans of several years. Given their rudimentary nature, IoT devices may also be particularly vulnerable to security threats.

IoT devices require management to maintain effective operation, for example to update software or security settings, and check battery levels. However, managing a large volume of IoT devices, and doing so within a cyber-secure environment, can be an onerous task, at least as to processing resources.

It is an aim of the present invention to at least alleviate some of the aforementioned problems.

### STATEMENTS OF INVENTION

According to a first aspect of the present invention, there is provided: a method of operating a telecommunications system, said telecommunications system comprising a: client device; certification server for generating a ticket for the client device; and network server for authenticating the client device using the ticket; the method comprising the steps of: selecting, by the certification server, a parameter associated with the client device; generating, by the certification server, a: rule for the selected parameter; ticket for authenticating the client device, wherein the ticket comprises: a parameter identifier for identifying to the client device the selected parameter; the rule; processing the ticket, by the client device, so as to retrieve the parameter identifier, and subsequently retrieving a data value for the selected parameter; generating a communication, by means of the client device, comprising the retrieved data value in cryptographic association with the ticket; communicating, by the client device, the communication to the network server; and decrypting and processing, by the network server, the communication so as to determine whether: the client device is trusted; and the retrieved data value is compliant with the rule. Optionally, the method is performed in the same sequence as the listed steps. Optionally, the client device is unauthenticated, at least by the network server, prior to the client device communicating the communication to the network server.

Preferably, decrypting the communication comprises decrypting the data value and ticket. Preferably, processing the communication comprises retrieving the rule, and optionally, the parameter identifier, from the ticket. Preferably, the client device is a battery-powered wireless network communication device, and in particular and Internet of Things device. Optionally, the ticket is generated according to a Kerberos protocol. Preferably, the client device, certification server and network server are interconnected via a telecommunications network, wherein said network may comprise: a fixed-access network; a wireless local area network; a wireless local area network; a cellular network; a satellite network; and/or a HetNet.

Preferably, the method further comprises the step of retrieving, at the certification server, information about the client device.

Preferably, the information comprises at least one of a/an: unique device identifier; device type; manufacturer; operator; user; location; model and/or serial number; network address; MAC address; Optionally, the information comprises a Manufacturer Usage Description file.

Preferably, the parameter is selected in dependence upon the retrieved information. Preferably, the rule is generated in dependence upon the retrieved information.

Preferably, in response to the network server determining that the client device is trusted and that the retrieved data value is compliant with the rule, the network server then permitting access, by the client device, to a network service. Optionally, the network service is: provided directly by the network server; provided by a further network server, different to the network server; and/or requested by the client device. Optionally, the network service comprises at least one of: data storage, processing, communication, and/or manipulation; a security function, which may include a security scan and/or security remediation; a networking function, which may include data connectivity, transportation and/or routing.

Preferably, in response to the network server determining that the client device is trusted and that the retrieved data value is non-compliant with the rule, the network server then preventing access, by the client device, to the, or a, network service.

Preferably, in response to the network server determining that the client device is trusted and that the retrieved data value is non-compliant with the rule, the network server then causing a remediation action so as to remediate said non-compliance of the client device and/or a mitigatory action so as to mitigate effects of said non-compliance of the client device. Optionally, said remediation action comprises at least one of: transmitting data to the client device; re-configuring the client device, which may include re-configuring a network configuration; resetting and/or restarting the client device; updating the client device; performing a security scan upon the client device; and/or removing malware from the client device. Optionally, said mitigatory action comprises at least one of: denying or preventing access by the client device to a, or the, network service; deactivating the client device or entering the client device into a low power mode (e.g. where battery level is non-compliant); and/or preventing network connectivity of the client device (e.g. where the client device is non-compliant with a network security rule).

Preferably, the communication and the ticket are each generated using the same or different encryption keys. Preferably, the encryption keys used to cryptographically associate the data value with the ticket, thereby to generate the communication, are provided within the ticket. Preferably, the network server then retrieves the encryption keys from the ticket, and subsequently uses said retrieved encryption keys to retrieve the data value.

Preferably, the parameter comprises at least one of a: software and/or operating system version; battery level; sensor reading; location; network configuration; network signal strength; and/or time elapsed since a last security scan.

Preferably, the method further comprises the step of, by the client device: processing the ticket so as to retrieve the rule; and determining whether the retrieved data value is compliant with the rule.

Preferably, subsequently communicating the communication by the client device to the network server is only performed in response to the client device determining that the retrieved data value is: non-compliant with the rule; or compliant with the rule.

Preferably, the method further comprises a further step of performing a data attestation process upon the retrieved data value so as to verify accuracy of the retrieved data. Preferably, the data attestation process is performed: locally, by the client device; and/or at a remote network location. Preferably, the data attestation process is performed before communicating the communication to the network server.

Preferably, the method is initiated by the certification server or by the client device requesting the ticket from the certification server. Preferably, the certification server pushes the ticket to the client device, without the ticket having been requested by the client device.

According to another aspect of the invention there is provided a computer-readable carrier medium comprising a computer program, which, when the computer program is executed by a computer, causes the computer to carry out the steps of any one of the methods described above.

According to yet another aspect of the invention there is provided a telecommunications system comprising: a client device; a certification server for generating a ticket for the client device, said certification server comprising a processor configured to: select a parameter associated with the client device; generate a rule for the selected parameter and a ticket for authenticating the client device, wherein the ticket comprises: a parameter identifier for identifying to the client device the selected parameter; the rule; a network server for authenticating the client device using the ticket; wherein the client device comprises a processor configured to: process the ticket so as to retrieve the parameter identifier, and subsequently retrieve a data value for the selected parameter; generate a communication comprising the retrieved data value in cryptographic association with the ticket; communicate the communication to the network server; and wherein the network server comprises a processor configured to: decrypt and process the communication so as to determine whether: the client device is trusted; and the retrieved data value is compliant with the rule.

According to yet other aspects of the invention there is provided corresponding methods of operating, individually, the certification server, client device and network server, as well as to said certification server, client device and network server themselves.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Any apparatus feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to a method of operating a telecommunications system, and a telecommunications system, as described herein and/or substantially as illustrated with reference to the accompanying drawings. The present invention is now described, purely by way of example, with reference to the accompanying diagrammatic drawings, in which:

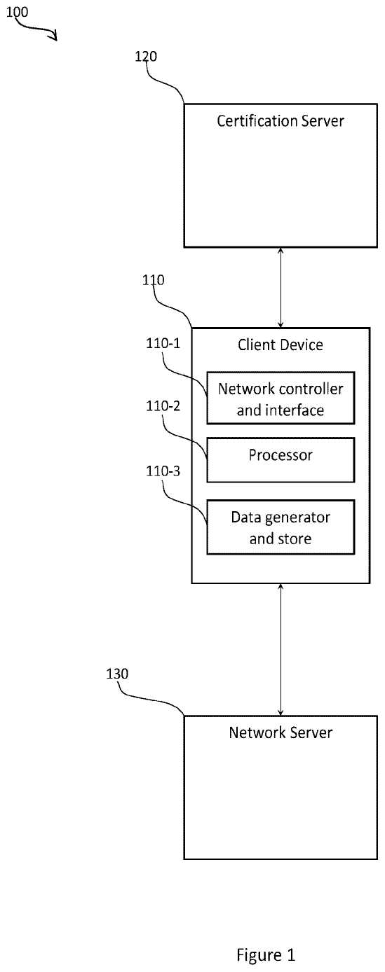

FIG. 1 shows a schematic diagram of a telecommunications system; and

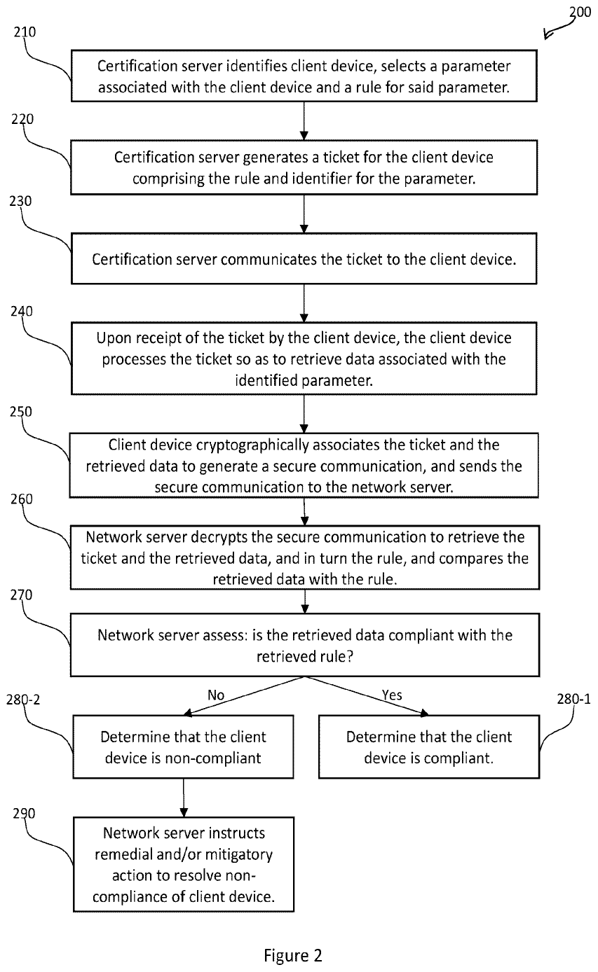

FIG. 2 shows a method of operating the telecommunications system.

### SPECIFIC DESCRIPTION

FIG. 1 shows a schematic diagram of an exemplary telecommunications system 100 comprising a: client device 110; certification server 120; and network server 130. The client device, certification server, and network server are in communication via a telecommunications network (functionally represented with interconnecting arrows). The telecommunications network exemplarily comprises: a local area network; a wide area network, a wireless network; a wired, or fixed-access, network; the Internet; and/or a private network.

The client device 110 is a wireless networked computing device, and is available to be in the form of a tablet, smartphone, laptop, wearable device and/or an IoT device. In particular, the client device comprises a: network controller and interface 110-1; processor 110-2; and data generator and store 110-3.

By means of the network controller and interface 110-1 and the telecommunications network, the client device is in communication with both the certification server 120 and the network server 130.

The data generator and store 110-3 is configured to generate, retrieve and store data, and in turn to communicate said data to the network controller and interface 110-1 for onward communication to the certification server 120 and/or network server 130. In particular, the data generator and store 110-3 comprises a sensor and memory for storing readings from the sensor. The sensor is available to be in the form of a/an:
ambient environmental and/or physical sensor, such as for measuring and/or recording: temperature; light; sound; force; weight; proximity; and/or location;
client device state sensor, such as for measuring an operating condition of the client device, including: battery level; software and/or operating system version/s; and/or time elapsed since a security scan; and/or
network sensor, such as for measuring: wireless signal strength; and visible proximate network devices.

In a specific example, the sensor is a force meter as used to measure fluid flow rate, such as in a gas or water meter.

The certification server 120 is a server configured to generate a ticket for the client device 110, and then communicate said ticket to the client device. The ticket authenticates the client device so as to permit the client device to access network services requiring authentication. For example, the certification server generates and communicates tickets according to the Kerberos protocol. The network services are available to include: data storage, processing, and/or manipulation; cybersecurity services; networking services, such as data connectivity, transportation and/or routing.

The certification server 120 is configured to receive, from the client device 110, or otherwise to generate, a unique identifier associated with the client device (e.g. a network identifier and/or a device serial number). As per known ticket-generation processes, the certification server is also configured to generate a ticket that is uniquely associated with the client device using the corresponding unique identifier, and that is cryptographically secured using private and public keys for the client device 110 and the certification server 120.

The certification server 120 is further configured to include within the ticket a parameter identifier for identifying a data parameter, and a rule for said identified parameter. The parameter identifier and the rule are encrypted as part of the ticket, which are therefore communicable within the secure environment of the ticket, and are therefore also retrievable by the client device 110.

The parameter is any variable (or set thereof) retrievable by the data generator and store (e.g. a reading from the ambient environmental and/or physical sensor, client device state sensor and/or network sensor). The parameter identifier is a pointer to a memory location within the data generator and store (specifically the memory) that corresponds with the identified parameter. The mapping of a parameter identifier to an identified parameter is available to be assigned and communicated to the client device by the certification server, or to be pre-defined and communicated to the certification server from the client device.

Using the parameter identifier, the client device 110 is configured to identify the selected parameter, and then to retrieve a current data value for said parameter.

The rule imposes a condition for the data value of the selected parameter, and in particular that the data value is: equal to; not equal to; greater than; and/or less than a specified value or set of values.

As described in more detail below, the telecommunications system is configured such that network server 130 verifies compliance of data values associated with the client device 110 based on the rule, in which the certification server, client device and data value and rule are derived using the secure environment of the ticket; FIG. 2 shows an exemplary process 200 of operating the telecommunications system in this way.

In a first step 210, the certification server 120 uniquely identifies the client device 110 by retrieving the unique identifier of the client device 110. The certification server 120 also selects the parameter associated with the client device and, then, based on the selected parameter, the rule. For example, the selected parameter is battery level of the client device, and the rule is a requirement that said battery level is greater than 25%.

In one example, selection of the parameter and/or the rule is performed by only the certification server 120 or by negotiation between the client device and the certification server (e.g. using an auto-negotiation process). In any event, the parameter and/or the rule is/are selected in dependence upon context information about the client device (e.g. if the context information is—or allows derivation—that client device is a personal medical sensor, then time elapsed since the last network security scan of the client device is selected as the parameter) or is/are predefined independently of any information about the client device (e.g. the same rule for every client device and/or a rule based on time of day).

Where context information about the client device 110 is used to select the parameter and/or the rule, the context information is received by the certification server 120 (e.g. either directly from the client device 110 and/or from another source accessible via the telecommunications network). Such context information is available to include:
associated entity information for the client device, including a/an user, operator, owner, and/or manufacturer of the client device;
intrinsic client device information, including a/an: device type and/or purpose information, such as the client device being an IoT device, a medical device and/or an industrial sensor, (e.g. as retrieved from a Manufacturer Usage Description file); and/or operating system; and/or
environmental context information, including a location of the client device.

Regardless of the manner in which the parameter and/or the rule is/are selected, in a next step 220, the certification server 120 generates a ticket that is uniquely associated with the client device 110, in which the ticket comprises the rule and the parameter identifier for the selected parameter. As part of the process to generate the ticket, the certification server retrieves cryptographic information (or credentials) for the client device, including the public key of the client device. The ticket is then generated using a cryptographic process, utilising the public key of the client device 110 and the private key of the certification server 120, so as to encrypt and render verifiable the ticket in a manner that will be appreciated by the person skilled in the art, as per known Digital Signature Algorithms (DSAs). The rule and the parameter identifier are correspondingly encrypted as part of the ticket.

Having generated the ticket, at a next step 230, the certification server 120 communicates the ticket to the client device 110 via the telecommunications network, and the ticket is received by the client device (specifically, by the network controller and interface 110-1).

At a subsequent step 240, the client device 110 processes the ticket, using the processor 110-2, by decrypting of the ticket, as per ticket-processing techniques that would be appreciated by the person skilled in the art. The client device 110 retrieves the parameter identifier and the rule from the ticket. From the parameter identifier, the client device 110 identifies the corresponding selected parameter. In turn, the processor 110-2 causes the data generator and store 110-3 to retrieve (e.g. from the associated sensor and/or memory) a current data value for the identified

At a next step 250, the client device 110 then cryptographically associates the ticket with the retrieved data value. For example, the client device 110 (specifically the processor 110-2) encrypts the retrieved data value using a corresponding cryptographic process as that used for generating the ticket (at step 220), such that the ticket and the data value are decryptable using the same, or related, decryption processes. Accordingly, the client device 110 outputs a secure communication comprising the retrieved data value and the ticket, which the client device communicates, via the telecommunications network, to the network server 130.

At a next step 260, upon receipt, the network server 130 decrypts the secure communication using a corresponding cryptographic process (e.g. that used for generating the ticket at step 220), thereby to output the ticket and the retrieved data value. In turn, from the ticket, the network server 130 determines that the ticket is uniquely associated with the client device 110 and authenticates the client device (as per known methods of authentication using tickets) as trusted, and then retrieves the rule. In one example, the cryptographic credentials for decrypting the ticket and/or the data value are provided directly by the certification server to the network server.

The network server 130 then performs an assessment 270, by comparing the retrieved data value with the rule, as to whether the retrieved data value is compliant with the rule.

In one eventuality 280-1, if the retrieved data value is compliant with the rule (e.g. battery level is greater than 25%), then the network server 130 determines that the client device 110 is compliant. Process 200 is then available to terminate or subsequently to reiterate to step 210 after a predetermined period of time (e.g. after one month), as triggered at the certification server 120.

In another eventuality 280-2, if the retrieved data value is non-compliant with rule (e.g. battery level is less than 25%), then the network server 130 determines that the client device 110 is non-compliant. Process 200 then proceeds to step 290, where, in response to the determination that the client device is non-compliant, the network server causes remedial action to resolve the non-compliance of the client device and/or mitigatory action to reduce detriment as a result of non-compliance.

The remedial action exemplarily comprises:
communicating a software update for the client device;
causing a security scan to be performed by the client device;
causing an engineer or technician to access and repair or otherwise reconfigure the client device;
rebooting or restarting the client device; and/or
reconfiguring a network configuration of the network device.

The mitigatory action exemplarily comprises:
denying or preventing access by the client device to the network server and/or a network service, and/or providing a modified network service to the client device;
deactivating the client device or entering the client device into a low power mode (e.g. where battery level is non-compliant); and/or
preventing network connectivity of the client device (e.g. where the client device is non-compliant with a network security rule);

In this way, compliance of the client device is monitorable by the network server securely using tickets, which simultaneously and efficiently allow for authentication of the client device and verification of compliance of the data values against the rule.

### Alternatives and Modifications

In an alternative, with reference to step 250, the client device encrypts the data values using a different encryption schema to that used to generate the ticket. Any encryption process that subsequently also permits the network server to retrieve the data value is available to be.

In a specific example, an encryption scheme for cryptographically associating the data value with the ticket (as performed at step 250) is provided (at least in part) within the ticket generated by the certification server 120 (as performed at step 220), for example, this includes the public key of the client device. Correspondingly, the network server 130 is therefore also available to decrypt the data value based on the decrypted contents (i.e. the encryption scheme) of the ticket.

In an alternative, process 200 comprises an attestation step (performed after step 240 and before steps 280), in which the accuracy (and not simply just the authenticity) of the data value is verified; this is available to be performed by the client device 110, network server 130 certification server 120 and/or any other networked entity remote to the client device 110, using known data attestation techniques, such as Direct Anonymous Attestation (DAA). In the event that the data attestation fails, process 200 is available to reiterate to cause the client device 110 to re-retrieve the data value (i.e. to step 240).

Each feature disclosed herein, and (where appropriate) as part of the claims and drawings may be provided independently or in any appropriate combination.

Any reference numerals appearing in the claims are for illustration only and shall not limit the scope of the claims.

1. A method of operating a telecommunications system, said telecommunications system comprising a:
client device;
certification server for generating a ticket for the client device; and
network server for authenticating the client device using the ticket;
the method comprising the steps of:
selecting, by the certification server, a parameter associated with the client device;
generating, by the certification server, a:
rule for the selected parameter;
ticket for authenticating the client device, wherein the ticket comprises:
a parameter identifier for identifying to the client device the selected parameter;
the rule;
processing the ticket, by the client device, so as to retrieve the parameter identifier, and subsequently retrieving a data value for the selected parameter;
generating a communication, by means of the client device, comprising the retrieved data value in cryptographic association with the ticket;
communicating, by the client device, the communication to the network server; and
decrypting and processing, by the network server, the communication so as to determine whether:
the client device is trusted; and
the retrieved data value is compliant with the rule.

2. A method according to claim 1, further comprising the step of retrieving, at the certification server, information about the client device.

3. A method according to claim 2, wherein the information comprises at least one of a/an: unique device identifier; device type; manufacturer; operator; user; location; model and/or serial number; network address; MAC address.

4. A method according to claim 1, wherein the parameter is selected in dependence upon the retrieved information, and wherein the rule is generated in dependence upon the retrieved information.

5. A method according to claim 1, wherein in response to the network server determining that the client device is trusted and that the retrieved data value is compliant with the rule, the network server then permitting access, by the client device, to a network service.

6. A method according to claim 1, wherein in response to the network server determining that the client device is trusted and that the retrieved data value is non-compliant with the rule, the network server then preventing access, by the client device, to the, or a, network service.

7. A method according to claim 1, wherein in response to the network server determining that the client device is trusted and that the retrieved data value is non-compliant with the rule, the network server then causing a remediation action so as to remediate said non-compliance of the client device and/or a mitigatory action so as to mitigate effects of said non-compliance of the client device.

8. A method according to claim 1, wherein the communication and the ticket are each generated using the same or different encryption keys.

9. A method according to claim 8, wherein the encryption keys used to cryptographically associate the data value with the ticket, thereby to generate the communication, are provided within the ticket.

10. A method according to claim 1, wherein the parameter comprises at least one of a: software and/or operating system version; battery level; sensor reading; location; network configuration; network signal strength; and/or time elapsed since a last security scan.

11. A method according to claim 1, further comprising the step of, by the client device:
processing the ticket so as to retrieve the rule; and
determining whether the retrieved data value is compliant with the rule.

12. A method according to claim 11, wherein subsequently communicating the communication by the client device to the network server is only performed in response to the client device determining that the retrieved data value is: non-compliant with the rule; or compliant with the rule.

13. A method according to claim 1, comprising a further step of performing a data attestation process upon the retrieved data value so as to verify accuracy of the retrieved data.

14. A computer-readable carrier medium comprising a computer program, which, when the computer program is executed by a computer, causes the computer to carry out the steps of claim 1.

15. A telecommunications system comprising:
a client device;
a certification server for generating a ticket for the client device, said certification server comprising a processor configured to:
select a parameter associated with the client device;
generate a rule for the selected parameter and a ticket for authenticating the client device, wherein the ticket comprises:
a parameter identifier for identifying to the client device the selected parameter;
the rule;
a network server for authenticating the client device using the ticket;
wherein the client device comprises a processor configured to:
process the ticket so as to retrieve the parameter identifier, and subsequently retrieve a data value for the selected parameter;
generate a communication comprising the retrieved data value in cryptographic association with the ticket;
communicate the communication to the network server; and
wherein the network server comprises a processor configured to:
decrypt and process the communication so as to determine whether:
the client device is trusted; and
the retrieved data value is compliant with the rule.
